(19) United States
(12) Patent Application Publication
(10) Pub. No.: US 2005/0135322 A1
(43) Pub. Date: Jun. 23, 2005

(54) Apparatus for modulation in base station with smart antenna

(76) Inventors: In Gi Lim, Daejeon-Shi (KR); Il Gyu Kim, Seoul (KR); Hyung Il Park, Daejeon-Shi (KR); Seung Chan Bang, Daejeon-Shi (KR); Hee Bum Jung, Daejeon-Shi (KR)

Correspondence Address: JACOBSON HOLMAN PLLC, 400 SEVENTH STREET N.W., SUITE 600, WASHINGTON, DC, 20004, US

(21) Appl. No.: 10/887,361

(22) Filed: Jul. 9, 2004

(30) Foreign Application Priority Data
Dec. 22, 2003 (JP) 2003-95039

(51) Int. Cl. H04B 7/216

(52) U.S. Cl. 370/342

(57) ABSTRACT

Provided is an apparatus for modulation in a base station with a smart antenna. The smart antenna system has many advantages that it is possible to deal with the large volume of subscribers; communication quality is increased; etc. However, the smart antenna system has disadvantages that cost is increased due to many antennas; base station transceivers have a complicated structure due to multiple antennas per base station; it is too complicated to manage resource and channel allocation; there is required compatibility with a conventional system; etc. The present invention provides an apparatus for modulation in a base station with a smart antenna, which can solve the foregoing problems by employing a modulator using a time division multiplexing method, a sector beam selector, and a TX beam former, thereby providing good compatibility regardless of a change in the number of base station sectors and the number of antennas.

### BACKGROUND

1. Field of the Invention

The present invention relates to an apparatus for modulation in a base station with a smart antenna.

2. Description of the Related Art

A smart antenna system uses multiple antenna elements and adjusts a gain and a phase of signals received from the respective antenna elements, so that a base station receives a signal transmitted from a user in only a desired direction and largely decreases a noise signal level due to multiple-access interference with signals transmitted from other directions, thereby improving performance of the system and increasing channel capacity of the base station. In particular, the smart antenna system is called an antenna array system to be applied to mobile communication, and its frequency efficiency has been recently exhausted. Further, according as the mobile communication has recently been improved in quality and the system adaptive to high-speed data transmission has actively researched, there have been studied on the smart antenna system and concern about the smart antenna system has been also growing.

In the smart antenna system, a concept of a spatial division multiple access (SDMA) system is used, so that the gain of the desired signal source is increased and thus a region corresponding to one base station is expanded, thereby reducing the number of the base stations as compared with those of a conventional system. Further, in the smart antenna system, only a selected signal source is intensively detected, so that power consumption of a terminal is reduced as compared with that of the conventional system, and thus call duration and battery lasting time of the terminal can be increased. Also, the smart antenna system allows one base station to serve more subscribers than that of the conventional system in the case of voice communication, and the high-speed data transmission to be possible in the case of data communication.

As compared with the conventional system, the smart antenna system has many advantages that it is possible to deal with the large volume of subscribers, communication quality is increased, etc. However, the smart antenna system has disadvantages that cost is increased due to an increase of many antennas; base station transceivers have a complicated structure due to the use of multiple antennas in the base station; it is too complicated to manage resource and channel allocation; there is required compatibility with a conventional system; etc.

On the other hand, in order to meet a wideband code division multiple access (WCDMA) specification, which is applied to the present invention, a base station modulator should perform modulation of physical channels in a forward link such as a dedicated physical channel (DPCH), a primary common control channel (P-CCPCH), a secondary common control channel (S-CCPCH), a physical downlink shared channel (PDSCH), a primary common pilot channel (P-CPICH), a secondary common pilot channel (P-CPICH), a primary synchronization channel (P-SCH), a secondary synchronization channel (S-SCH), an acquisition indicator channel (AICH), an access preamble acquisition indicator channel (AP-AICH), a collision detection/ channel assignment indicator channel (CD/CA-ICH) and a paging indicator channel (PICH).

### SUMMARY OF THE INVENTION

The present invention is directed to an apparatus for modulation in a base station with a smart antenna, which can solve problems such as bulky hardware components for modulation and low compatibility due to a change in the number of base station sectors and the number of antennas, that is, a time division multiplexing method is fully used to decrease reliance on the hardware components, and a sector beam selector and a TX beam former are used to be compatible with a conventional base station system without separate hardware components, for example, one hardware component allows a smart antenna base station system of 3 sectors and 8 antennas to be readily compatible with a conventional base station system of 3 sectors and 2 antennas or 6 sectors and 2 antennas.

To achieve the above purposes, one aspect of the present invention provides an apparatus for modulation in a base station with a smart antenna, the apparatus comprising: a multiplexing modulator having a time division multiplexing structure; a plurality of non-multiplexing modulators which does not have the time division multiplexing structure; a channel adder adding outputs of the plurality of non-multiplexing modulators; a sector beam selector outputting a plurality of beam signals, wherein each beam signal is a signal obtained by adding a signal of the multiplexing modulator, which is accumulated during a multiplexing period after controlling each output signal to be turned on/off, to each output signal of the channel adder, which is controlled to be turned on/off, or a signal accumulated during the multiplexing period after controlling the outputs of the multiplexing modulator to be turned on/off; and a TX beam former outputting a plurality of antenna signals to a plurality of antennas, wherein each antenna signal is a signal obtained by adding the plurality of beam signals after being multiplied with a plurality of weights.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 is a view illustrating an apparatus for modulation in a base station with a smart antenna according to an embodiment of the present invention;

FIG. 2 is a view illustrating a detailed structure of the channel selector in FIG. 1;

FIG. 3 is a view illustrating a detailed structure of the sector beam selector in FIG. 1; and

FIG. 4 is a view illustrating a detailed structure of the TX beam former in FIG. 1.

### DETAILED DESCRIPTION OF THE INVENTION

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art.

According to the present invention, an apparatus for modulation in a base station with a smart antenna has developed to meet a WCDMA specification employed in 3^{rd} generation partnership project (3GPP), but may be applied to a CDMA2000 employed in 3GPP2 or a specification employed in 4^{th} generation partnership project (4GPP) or the like which is being currently developed.

In the present invention, a smart antenna system will be described by way of example, which requires parameters as follows: 3 sectors, 12 beams per sector, and 8 antennas per sector. Further, in a base station system, it is important to accept a plurality of subscribes at one channel card in order to secure realization efficiency and saving of expenses, therefore the base station system will be described by way of example, which comprises a DPCH of 32 channels and a dedicated S-CPICH of 32 channels.

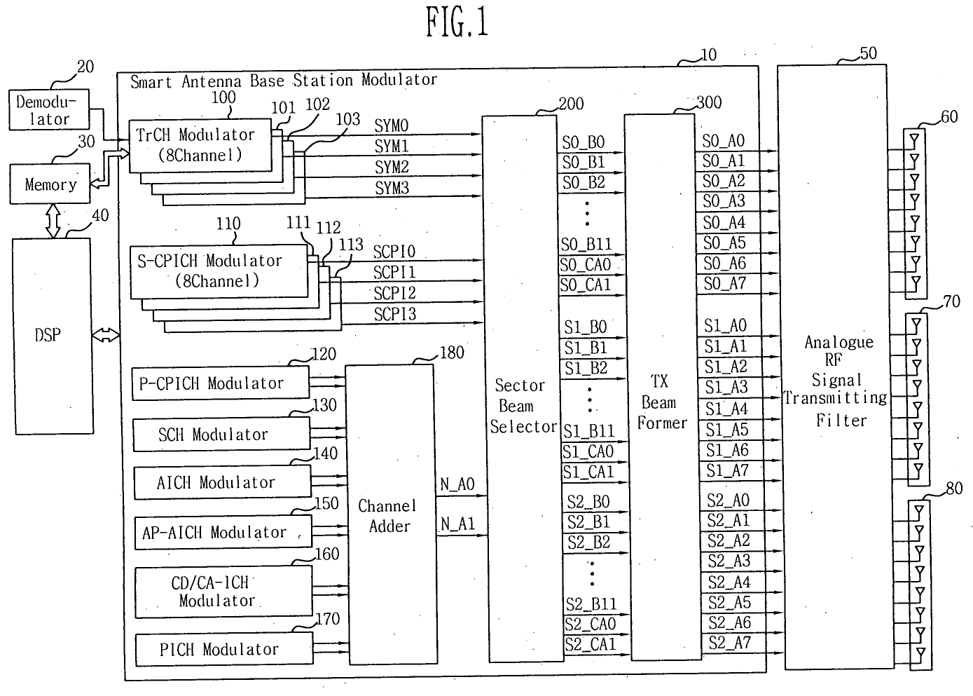

FIG. 1 is a view illustrating an apparatus for modulation in a base station with a smart antenna according to an embodiment of the present invention.

Referring to FIG. 1, a digital signal processor (DSP) 40 controls a smart antenna base station modulator 10 through a storage/read register, and provides input data to be modulated by TrCH modulators 100, 101, 102 and 103 via an external memory 30. The smart antenna base station modulator 10 is composed of 32-channel TrCH modulators 100, 101, 102 and 103; 32-channel S-CPICH modulators 110, 111, 112 and 113; a P-CPICH modulator 120; an SCH modulator 130; an AICH modulator 140; an AP-AICH modulator 150, a CD/CA-ICH modulator 160; a PICH modulator 170; a channel adder 180; a sector beam selector 200; and a TX beam former 300. The smart antenna base station modulator 10 outputs signals to three sectors of eight antennas 60, 70 and 80 via an analog radio frequency (RF) transmitting filter 50.

The TrCH modulator 100 performs modulation of TrCH encoding channels among forward link channels, that is, DPCH, P-CCPCH, S-CCPCH, and PDSCH. Here, the highest speed of clock to be processed in the TrCH modulator 100 is a chip speed clock (CHIPX1), so that a clock (CHIPX8) that is eight times faster than the chip speed is used for time division multiplexing. Hence, eight channels are processed by the minimum hardware at the same time. As shown in FIG. 1, when four TrCH modulators are connected in parallel, it is possible to process the maximum thirty-two independent channels. The TrCH modulators 100, 101, 102 and 103 each having eight channels output signals SYM0, SYM1, SYM2 and SYM3, respectively. In four signals SYM0, SYM1, SYM2 and SYM3, signals of antenna0 and antenna1 resulted from STTD encoding are combined with signals of I-channel and Q-channel each corresponding to the antenna0 and antenna1 in a bus form. Here, like a period of the CHIPX1, a period for which time division multiplexing is performed is called a multiplexing period. Further, like the TrCH modulator 100, a modulator performing the time division multiplexing is called a multiplexing modulator. Contrarily, a modulator that does not perform the time division multiplexing is called a non-multiplexing modulator.

The S-CPICH modulator 110 is a block used for processing the dedicated S-CPICH. Like the TrCH modulator 100, one block of the S-CPICH modulator 110 uses the CHIPX8 for the time division multiplexing, thereby processing eight channels. Hence, when four S-CPICH modulators 110 are connected in parallel, it is possible to process maximum thirty-two independent S-CPICH channels. Thirty-two S-CPICH channels of four S-CPICH modulators 110, 111, 112 and 113 output signals SCPI0, SCPI1, SCPI2 and SCPI3, respectively. In four signals SCPI0, SCPI1, SCPI2 and SCPI3, the signals of the antenna0 and antenna1 resulted from STTD encoding are combined in a bus form with the signals of the I-channel and Q-channel each corresponding to the antenna0 and antenna1.

The P-CPICH modulator 120 performs modulation in the forward link channel such as the P-CPICH. The SCH modulator 130 performs modulation in the P-SCH and the S-SCH. The AICH modulator 140 performs modulation in the AICH. The AP-AICH modulator 150 performs modulation in the AP-AICH. The CD/CA-ICH modulator 160 performs modulation in the CD/CA-ICH. The PICH modulator 170 performs modulation in the PICH. Here, detailed inner structures and functions of these modulator blocks are not claimed, and therefore descriptions thereof will be omitted.

The P-CPICH modulator 120, the SCH modulator 130, the AICH modulator 140, the AP-AICH modulator 150, the CD/CA-ICH modulator 160, the PICH modulator 170 output signals corresponding to the antenna0 and the antenna1 at a speed of spreading factor 256 (SF256), and each antenna output value is a complex number of the I-channel and the Q-channel, which is inputted to the channel adder 180.

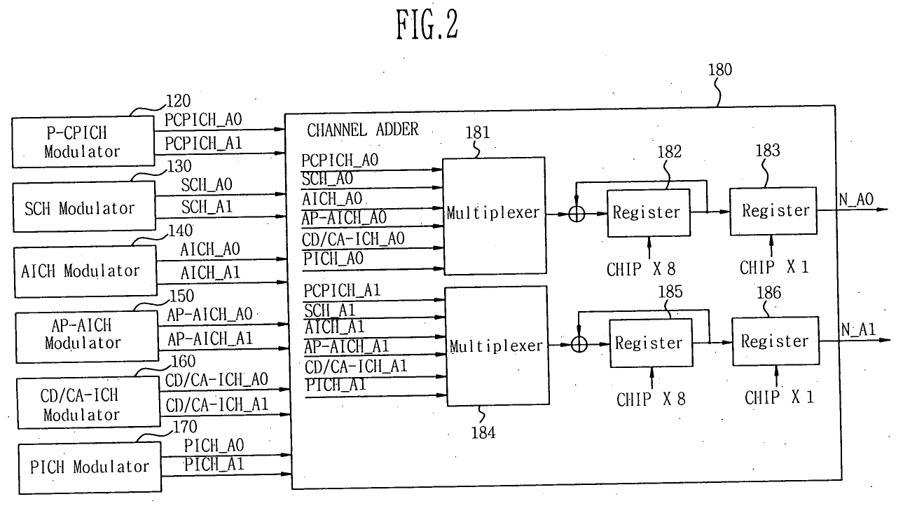

FIG. 2 is a view illustrating a detailed structure of the channel adder 180 in FIG. 1.

Referring to FIG. 2, P-CPICH_A0 and P-CPICH_A0 outputted from the P-CPICH modulator 120, SCH_A0 and SCH_A1 outputted from the SCH modulator 130, AICH_A0 and AICH-A1 outputted from the AICH modulator 140, AP-AICH_A0 and AP-AICH_A1 outputted from the AP-AICH modulator 150, CD/CA-ICH_A0 and CD/CA-ICH_A1 outputted from the CD/CA-ICH modulator 160, and PICH_A0 and PICH_A1 outputted from the PICH modulator 170 are divided according to the antennas. In the case of the antenna0, they are multiplexed by a multiplexer 181 at a speed of the CHIPX8 and are outputted, and sequentially added by an accumulator composed of an adder and a register 182 at the speed of the CHIPX8. The accumulated value is stored by a register 183 at the speed of the CHIPX1, thereby allowing the channel adder of the antenna0 to create N_A0. Actually, this value is a complex number including values of the I-channel and the Q-channel. Likewise, in the case of the antenna1, they are multiplexed by a multiplexer 184 and accumulated by an accumulator composed of an adder and a register 185, and the accumulated value is stored by a register 186 at the speed of CHIPX1, thereby allowing the channel adder of the antenna1 to create N_A1.

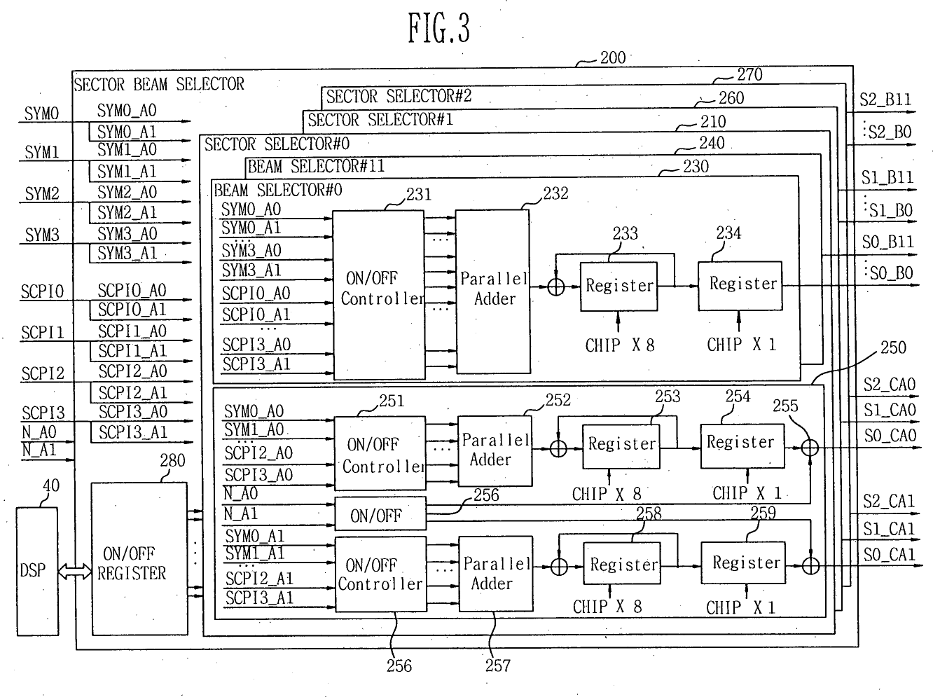

FIG. 3 is a view illustrating a detailed structure of the sector beam selector 200 in FIG. 1.

As shown in FIG. 3, the sector beam selector 200 performs an on/off function by selecting sectors and beams, each of which must be transmitted for total thirty-two channels of four TrCH modulators (SYM0, SYM1, SYM2, SYM3), total thirty-two channels of four S-CPICH modulators (SCPI0, SCPI1, SCPI2, SCPI3), and the outputs (N_A0, N_A1) of the channel adder, and performs a function of adding the on/off controlled channel values according to the selected sectors and beams.

Each output of the thirty-two channels of four TrCH modulators and each output of the thirty-two channels of four S-CPICH modulators is inputted to a common beam selector and all beam selectors with respect to all sectors, and the DSP stores on/off control values in an on/off register 280 with respect to each output of the channels, thereby flexibly controlling the output of the random channel to be transmitted to any beam of any sector.

When the DPCH channel of the forward link is set, at the beginning, the DPCH channel of the reverse link is not set and therefore it is impossible to know a direction of a terminal, thereby transmitting the output of the corresponding DPCH channel to the common beam. This is implemented by the DSP, wherein the DSP controls the on/off value of the on/off register 280 corresponding to the common beam selector 250. After the forward link DPCH channel is set to the common beam, the reverse link DPCH is synchronized. After the reverse link beam is formed by a receiver, the channel setting is changed from the common beam selector to a beam selector #0 through a beam selector #11.

The sector beam selector 200 is composed of three sector selectors 210, 260 and 270, and the on/off register 280 to control the DSP, wherein each sector selector is composed of twelve beam selectors from the beam selector#0 to the beam selector#11, and the common beam selector 250.

Each of the time division multiplexed output values SYM0, SYM1, SYM2, SYM3, SCPI0, SCPI1, SCPI2 and SCPI3 from eight channels to be inputted to the beam selector#0, which are combined by the TrCH modulator and S-CPICH modulator as the bus, is divided into values of the antenna0 and the antenna1. The divided values have a complex value of the I-channel and the Q-channel. An on/off controller 231 controls each of sixteen inputs SYM0_A0, SYM0_A1, SYM1_A0, SYM1_A1, SYM2_A0, SYM2_A1, SYM3_A0, SYM3_A1, SCPI0_A0, SCPI0_A1, SCPI1_A0, SCPI1_A1, SCPI2_A0, SCPI2_A1, SCPI3_A0, and SCPI3_A1 to be turned on/off. Here, these sixteen inputs are time division multiplexed at the speed of CHIPX8, so that the on/off-controlled channel values are added by a parallel adder 232. The outputs of the parallel adder 232 are accumulated by the accumulator composed of the adder and the register 233 at the speed of CHIPX8, and updated by the register 234 at the speed of CHIPX1, thereby creating S0_B0 (sector0, beam0). Likewise, the other eleven beam selectors are operated to create S0_B1, S0_B2, . . . , S0_B11. Likewise, the sector selector#1 260 and the sector selector#2 270 are operated to create S1_B0, S1_B1, . . . , S1_B11, S2_B0, S2_B1, . . . , S2_B11.

Eight signals of the common beam selector 250 in the sector selector#0 210, that is, SYM0_A0, SYM1_A0, SYM2_A0, SYM3_A0, SCPI0_A0, SCPI1_A0, SCPI2_A0 and SCPI3_A0 are inputted to an on/off controller 251 to be turned on/off. The eight outputs of the on/off controller 251 are added by a parallel adder 252. Then the added outputs are accumulated by the accumulator composed of the adder and the register 253 at the speed of CHIPX8, and updated by the register 254 at the speed of CHIPX1. The updated values are added, to an output N_A0 of the channel adder controlled by an on/off controller 256, by an adder 255, thereby creating S0_CA0 (sector0, common beam, antenna0). Likewise, S0_CA1 (sector0, common beam, antenna1) is created from eight signals SYM0_A1 SYM1_A1, SYM2_A1, SYM3_A1, SCPI0_A1, SCPI1_A1, SCPI2_A1, and SCPI3_A1 and output N_A1. Likewise, the common beam selectors in the sector selector#1 260 and the sector selector#2 270 are operated to create S1_CA0, S1_CA1, . . . , S1_CA11, S2_CA0, S2_CA1, . . . , S2_CA11.

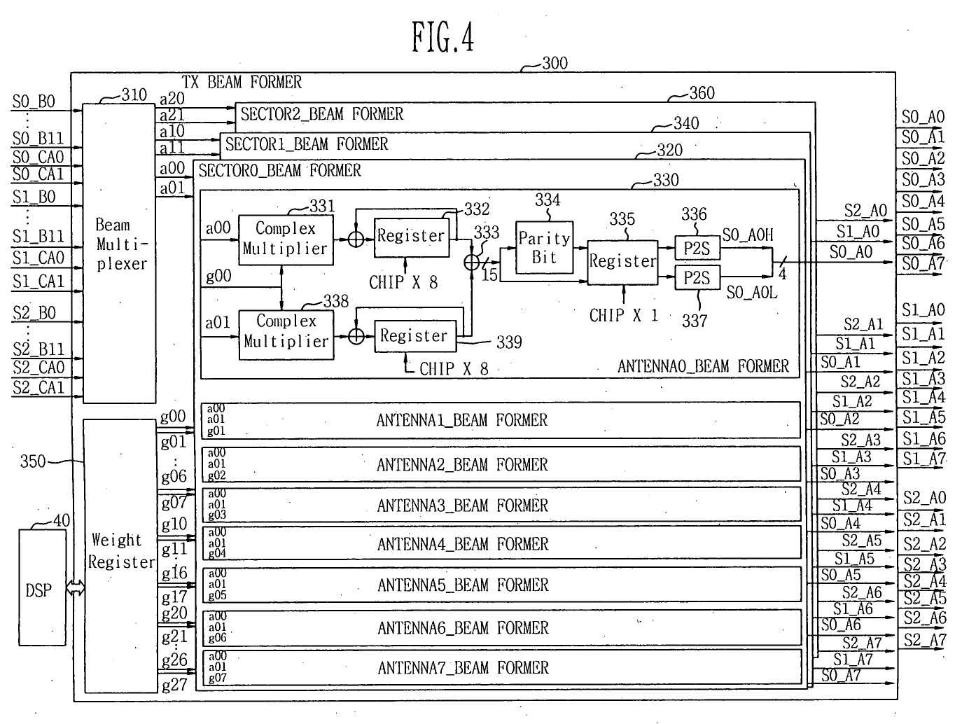

FIG. 4 is a view illustrating a detailed structure of the TX beam former 300 in FIG. 1.

Referring to FIG. 4, the TX beam former 300 forms beams according to the sectors and performs an output interface with a weight calculated by the DSP 40 and provided through a weight register 350.

The TX beam former 300 employs the following time division multiplexing method to use the minimum hardware. The outputs of the sector beam selector inputted to the TX beam former 300 are multiplexed by a beam multiplexer 310 into two groups every three sectors, thereby creating a00 and a01 for the sector0, a10 and all for the sector1, a20 and a21 for the sector 2. For instance, in the case of a00 and a01 for the sector0, a00 is multiplexed into seven values S0_B0, S0_B2, . . . , S0_B10, S0_CA0 in sequence at the speed of CHIPX8, and a01 is multiplexed into seven values S0_B1, S0_B3, . . . , S0_B11, S0_CA1 in sequence at the speed of CHIPX8. The DSP 40 stores a weight of each antenna according to the sectors and beams in the weight register 350, so that the output g00 of the weight register 350 is outputted by multiplexing a weight according to each of the beams of the sector0 and antenna0 at the speed of the CHIPX8, depending on the multiplexing sequence of a00 and a01. Likewise, a weight according to each of the sectors, beams and antennas is multiplexed at the speed of the CHIPX8, thereby outputting g00, g01, . . . , g07, g10, g11, . . . , g17, g20, g21, . . . , g27.

A sector0_beam former 320 is composed of eight sub-blocks such as an antenna0_beam former 330, an antenna1_beam former, . . . an antenna7_beam former 330. The antenna0_beam former 330 receives the outputs a00 and a01 corresponding to the sector0 and the weight g00 of the weight register corresponding to the sector0 and antenna0 among the outputs of the beam multiplexer 310. The outputs a00 and a01 are the complex numbers and are complex-multiplied with the weight g00 by complex multipliers 331 and 338. The outputs of the complex multipliers are accumulated by the accumulator composed of the adder and the register 332, 339 at the speed of CHIPX8, and then added by an adder 333.

In the apparatus for modulation in the base station with the smart antennas, the output of the final adder 333 is 15 bits. By the way, in consideration of three sectors, eight antennas, and the I- and Q-channels, total output is 720 bits which is too large to realize the system. To solve this problem within the given clocks, a parity check 334 of 1 bit is added to a top of the adder output of 15 bits and then stored in the register 335 at the speed of CHIPX1. Then, the output is parallel-serial converted 336 and 337 according to whether the bit is odd or even, thereby being converted into a complex value S0_A0 of 2 bits. Thus, after performing the output interface, the final output of the base station modulator is total 96 bits because 2 bits are given to the I- and Q-channels, three sectors, and eight antennas.

Likewise, the antenna1_beam former, the antenna2_beam former, the antenna3_beam former, the antenna4_beam former, the antenna5_beam former, the antenna6_beam former and the antenna7_beam former are operated to create S0_A1, S0_A2, S0_A3, S0_A4, S0_A5, S0_A6 and S0_A7 as to the outputs of the sector0. Like the sector0_beam former 320, the sector1_beam former 340 and the sector2_beam former 360 are operated to create S1_A0, S1_A2, . . . , S1_A7, and S2_A0, S2_A1, S2_A7, respectively.

As described above, the present invention provides a simple apparatus for modulation.

Further, the present invention provides an apparatus for modulation in a base station with a smart antenna, which has good compatibility regardless of a change in the number of base station sectors and the number of antennas.

While the present invention has been described with reference to a particular embodiment, it is understood that the disclosure has been made for purpose of illustrating the invention by way of examples and is not limited to limit the scope of the invention. And one skilled in the art can make amend and change the present invention without departing from the scope and spirit of the invention, the scope of which is defined in the appended claims and their equivalents.

1. An apparatus for modulation in a base station with a smart antenna, the apparatus comprising:
a multiplexing modulator having a time division multiplexing structure;
a plurality of non-multiplexing modulators which does not have the time division multiplexing structure;
a channel adder adding outputs of the plurality of non-multiplexing modulators;
a sector beam selector outputting a plurality of beam signals, wherein each beam signal is a signal obtained by adding a signal, which is accumulated during a multiplexing period after controlling each output signal of the multiplexing modulator to be turned on/off, to each output signal of the channel adder, which is controlled to be turned on/off, or a signal accumulated during the multiplexing period after controlling each output signal of the multiplexing modulator to be turned on/off; and
a TX beam former outputting a plurality of antenna signals to a plurality of antennas, wherein each antenna signal is a signal obtained by adding the plurality of beam signals after being multiplied with a plurality of weights.

2. The apparatus as claimed in claim 1, wherein the multiplexing modulator includes a TrCH modulator and an S-CPICH modulator, and
the plurality of non-multiplexing modulators includes a P-CPICH modulator, an SCH modulator, an AICH modulator, an AP-AICH modulator, a CD/CA-ICH modulator, and a PICH modulator.

3. The apparatus as claimed in claim 1, wherein the channel adder includes:
a multiplexer processing the outputs of the non-multiplexing modulators by time division multiplexing;
an accumulator accumulating the outputs of the multiplexer during the multiplexing period;
a register storing and outputting a value accumulated by the accumulator during the multiplexing period.

4. The apparatus as claimed in claim 1, wherein the sector beam selector includes a single selector or a plurality of sector selectors,
the sector selector includes a plurality of beam selectors and a single common beam selector;
the beam selector controls each output signal of the multiplexing modulator to be turned on/off and then accumulates and outputs during the multiplexing period; and
the common beam selector adds and outputs each output signal of the multiplexing modulator, which is controlled to be turned on/off and then accumulated during the multiplexing period, to each output signal of the channel adder, which is controlled to be turned on/off.

5. The apparatus as claimed in claim 4, wherein the common beam selector is used in a state that a reverse link DPCH is not synchronized and a reverse link beam is not formed, and
the beam selector is used in a state that the reverse link DPCH is synchronized and the reverse link beam is formed.

6. The apparatus as claimed in claim 4, wherein the beam selector includes:
an on/off controller controlling each output signal of the multiplexing modulator to be turned on/off and outputted;
a parallel adder adding the outputs of the on/off controller;
an accumulator accumulating the outputs of the parallel adder during the multiplexing period; and
a register storing and outputting a value accumulated by the accumulator during the multiplexing period.

7. The apparatus as claimed in claim 4, wherein the common beam selector includes:
a first on/off controller controlling each output signal of the multiplexing modulator to be turned on/off and outputted;
a second on/off controller controlling each output signal of the channel adder to be turned on/off and outputted;
a parallel adder adding the outputs of the first on/off controller;
an accumulator accumulating the outputs of the parallel adder during the multiplexing period;
a register storing and outputting a value accumulated by the accumulator during the multiplexing period; and
an adder adding the outputs of the register to the outputs of the second on/off controller.

8. The apparatus as claimed in claim 1, wherein the TX beam former includes a beam multiplexer and a single sector beam former or a plurality of sector beam former to process the outputs of the sector beam selector by the time division multiplexing;
each sector beam former includes a plurality of antenna beam formers; and
the antenna beam former outputs a value accumulated during the multiplexing period by parallel-serial converting after multiplying the outputs of the beam multiplexer with the weight.

9. The apparatus as claimed in claim 8, wherein the antenna beam former includes:
a complex multiplier complex-multiplying the outputs of the beam multiplexer with the weight;
an accumulator accumulating the outputs of the complex multiplier during the multiplexing period;
a parity bit calculator calculating a parity bit of the outputs of the accumulator;
a register storing the value accumulated by the accumulator during the multiplexing period and the parity bit to be outputted; and
a serial converter converting the outputs of the register into a serial signal.
